(19) United States
(12) Patent Application Publication
(10) Pub. No.: US 2024/0401262 A1
(43) Pub. Date: Dec. 5, 2024

(54) WASHING MACHINE HAVING DRYING FUNCTION

(71) Applicant: SAMSUNG ELECTRONICS CO., LTD., Suwon-si Gyeonggi-do (KR)

(72) Inventors: Hyounyoung LEE, Suwon-si (KR); Younghyun KIM, Suwon-si (KR); Heejin KANG, Suwon-si (KR); Seulgi LEE, Suwon-si (KR); Seungil LIM, Suwon-si (KR)

(73) Assignee: SAMSUNG ELECTRONICS CO., LTD., Suwon-si Gyeonggi-do (KR)

(21) Appl. No.: 18/804,410

(22) Filed: Aug. 14, 2024

Related U.S. Application Data
(63) Continuation of application No. PCT/KR2022/020717, filed on Dec. 19, 2022.

(30) Foreign Application Priority Data
Feb. 15, 2022 (KR) 10-2022-0019429

(51) Int. Cl. D06F 58/22; B01D 46/00; B01D 46/16; B01D 46/681; D06F 25/00; D06F 58/20

(52) U.S. Cl. CPC D06F 58/22; B01D 46/0006; B01D 46/16; B01D 46/681; D06F 25/00; D06F 58/206; B01D 2279/55

(57) ABSTRACT

A washing machine having a drying function including: a tub; a drum inside the tub; a heat exchanger above the tub for heating air supplied into the tub; an air blowing fan to guide air through a circulating flow path passing through the tub and the heat exchanger, a filter case disposed on one side of the main body; and a filter module coupleable to and decouplable from the filter case. The filter module may include: a filter mesh; and a cleaning member which sweeps the filter mesh to separate foreign substances caught in the filter mesh as the filter module is decoupled from the filter case.

### CROSS-REFERENCE TO RELATED APPLICATIONS

This application is a continuation of International Application PCT/KR2022/020717, filed Dec. 19, 2022, and claims priority to Korean Application No. 10-2022-0019429, filed Feb. 15, 2022, which are incorporated herein by reference in their entireties.

### TECHNICAL FIELD

The following embodiments relate to a filter module and connection module assembly for a washing machine having a drying function.

### BACKGROUND ART

A washing machine refers to a device adapted to perform laundering by performing the steps of washing, rinsing, and dewatering, and a drying machine refers to a device adapted to dry wet laundry. A washing machine having a drying function, or a washing-drying machine herein, refers to a device adapted to perform the steps of washing, rinsing, and dewatering and then complete laundering by drying.

The washing-drying machine may have a drying device that generally supplies hot air heated by a heating unit to the inside of a drum in which the laundry is located and evaporates water from the laundry. The evaporated water may then be condensed by a condensing unit provided in the washing-drying machine and discharged to the outside to complete drying the laundry.

The above description is information the inventor(s) acquired during the course of conceiving the present disclosure, or already possessed at the time, and is not necessarily art publicly known before the present application was filed.

### DISCLOSURE OF THE INVENTION

### Technical Solutions

According to various embodiments, provided is a filter module that facilitates the removal of dirt adhering to a filter mesh by being withdrawn from a washing-drying machine.

According to various embodiments, provided is a filter module that, when mounted in a washing-drying machine, supplies hot dry air to a drum without a loss in a flow path as a dust outlet of the filter module is closed.

According to various embodiments, provided is a filter module that, when mounted in a washing-drying machine, prevents dust collected in a dust collection space from escaping into the surroundings as a dust outlet of the filter module is closed.

According to various embodiments, provided is a filter module that facilitates the discharge of dust collected in a dust collection space to the outside as a dust outlet of the filter module is open when the filter module is mounted in a connection module.

According to various embodiments, provided is a filter module that is completely removable from a washing-drying machine and is thus cleaned effectively.

According to various embodiments, a washing machine having a drying function, or a washing-drying machine herein, may include: a main body having a laundry inlet provided at the front of the washing machine; a tub disposed inside the main body; a drum rotatably disposed inside the tub; a heat exchanger disposed above the tub and configured to heat air supplied into the tub; a fan configured to guide air through a circulating flow path that passes through the tub and the heat exchanger; a filter case disposed on one side of the main body; and a filter module coupleable to and decouplable from the filter case. The filter module may include: a filter mesh; and a cleaning member configured to sweep the filter mesh to separate foreign substance caught in the filter mesh as the filter module is decoupled from the filter case.

According to an embodiment, the air discharged from the tub may flow into the filter module along a first direction and the air is supplied to the heat exchanger by being discharged through the filter mesh along a second direction perpendicular to the first direction.

The filter module may comprise a first filter on which the filter mesh is formed.

According to various embodiments, at least a portion of the cleaning member may be in contact with the filter mesh, and the at least the portion of the cleaning member is displaced as the filter module is being decoupled from the filter case.

The cleaning member may be in a form of a square ring, and the cleaning member sweeps the filter mesh as the filter module is moved such that the filter module and the filter case decouple from each other.

The filter module may include a slit formed to extend along the filter module, and a guide rib formed to extend along the filter module.

According to various embodiments, the cleaning member may be formed to extend inside the filter case perpendicular to the filter mesh.

An area of the cleaning member extends across an area of the filter mesh.

The washing machine may include a dust collection space between the filter case and the filter module, and the cleaning member may be arranged inside the dust collection space between the filter case and the filter module.

The filter module may include a filter mesh face arranged in a shape in which a left side and a right side are inverted, and the filter module is coupled to the filter case by being slid along the filter case.

The cleaning member may extend toward the filter mesh face of the filter module.

According to various embodiments, the washing machine having a drying function may include a main body having a laundry inlet at a front of the washing machine, a tub disposed inside the main body, a drum rotatably disposed inside the tub, a heat exchanger disposed above the tub and configured to heat air supplied into the tub, a fan configured to guide air through a circulating flow path that passes through the tub and the heat exchanger, a filter case disposed on one side of the main body; and a filter module coupleable to the filter case and decouplable from the filter case such that while the filter module is coupled to the filter case and the main body, air discharged from the tub flows through the filter module and is supplied toward the heat exchanger.

The filter module may comprise a filter mesh through which the air supplied toward the heat exchanger is discharged while the filter module is while the filter module is coupled to the filter case, and a cleaning brush configured to sweep the filter mesh to separate foreign substance caught in the filter mesh.

The cleaning brush may be in contact with the filter mesh.

The cleaning brush may be displaceable with respect to the filter mesh.

The filter mesh may be formed on a filter mesh face perpendicular to one open side on which a filter inlet is formed.

The filter case may be connected to the outlet duct and the heat exchange duct, and the filter case may extend from one side of the rear upper portion in the main body to one side of a front upper portion in the main body.

The filter case may include a filter case inlet connected to the outlet duct, and a filter case outlet connected to the heat exchange duct.

According to various embodiments, a washing-drying machine using a filter module insertable into a filter connection module may include: a main body having a laundry inlet provided at the front; a tub disposed inside the main body to store water therein; a drum rotatably disposed inside the tub; a heat exchanger disposed above the tub and adapted to heat air supplied into the tub; an air blowing fan adapted to form a circulating flow path that passes through the tub and the heat exchanger; a filter case having a filter case inlet provided at the rear such that air discharged from the tub flows in and a filter case outlet provided at the side such that air is supplied to the heat exchanger; and the filter module disposed to be received in the inside of the filter case or withdrawn to the outside of the filter case. The tub may include an outlet at a rear lower side and an inlet at a front upper side. The circulating flow path may include: an outlet duct connected to the outlet and extending from the rear lower side of the tub to one side of a rear upper portion in the main body; the filter case connected to the outlet duct and extending from one side of the rear upper portion in the main body to one side of a front upper portion in the main body; a heat exchange duct connected to the filter case and extending from one side of the front upper portion in the main body to another side; and a supply duct connected to the heat exchange duct and connected to the inlet. The filter module may be inserted into a filter insertion portion provided within the filter case, and the filter module may include: a first filter including a first filter inlet formed toward the filter case inlet and including a first filter mesh formed to face the filter case outlet when the filter module is received in the inside of the filter case; a second filter including a second filter inlet formed toward the filter case inlet and including a second filter mesh formed to face the first filter mesh, with at least a portion of the second filter being received in the first filter; a dust collection space formed between the first filter and the second filter; a dust outlet formed around the first filter inlet and connecting the dust collection space and the outside of the first filter; and a dust outlet cover covering the dust outlet. Air in the filter case may enter the first filter inlet and pass through the second filter mesh and the first filter mesh to move into the heat exchange duct.

According to various embodiments, a washing-drying machine using a filter module insertable into a filter connection module may include: a main body having a door provided at the front, the main body having a laundry inlet provided at the front; a tub disposed inside the main body to store water therein; a drum rotatably disposed inside the tub; a heat exchanger disposed above the tub and adapted to heat air supplied into the tub; an air blowing fan adapted to form a circulating flow path that passes through the tub and the heat exchanger; a filter case having a filter case inlet provided at the rear such that air discharged from the tub flows in and a filter case outlet provided at the side such that air is supplied to the heat exchanger; and the filter module disposed to be received in the inside of the filter case or withdrawn to the outside of the filter case. The tub may include an outlet at a rear lower side and an inlet at a front upper side. The circulating flow path may include: an outlet duct connected to the outlet and extending from the rear lower side of the tub to one side of a rear upper portion in the main body; the filter case connected to the outlet duct and extending from one side of the rear upper portion in the main body to one side of a front upper portion in the main body; a heat exchange duct connected to the filter case and extending from one side of the front upper portion in the main body to another side; and a supply duct connected to the heat exchange duct and connected to the inlet. The filter module may be inserted into a filter insertion portion provided within the filter case, and the filter module may include: a first filter of which one surface is open and including a first filter mesh on a surface perpendicular to the open surface; a second filter of which one surface in the same direction as the open surface of the first filter is open and including a second filter mesh formed on a surface toward the first filter mesh, with at least a portion of the second filter being received in the first filter; a dust collection space formed between the first filter and the second filter; a dust outlet formed around the open surface of the first filter and connecting the dust collection space and the outside of the first filter; and a dust outlet cover covering the dust outlet. Air in the filter case may enter the open surface of the first filter and pass through the second filter mesh and the first filter mesh to move into the heat exchange duct. The connection module may include: a connection module body; a receiving space formed inside the connection module body into which at least a portion of the first filter is to be inserted; a connection module inlet formed at one end of the connection module body and connected to the receiving space; a connection module outlet formed at another end of the connection module body and connected to the receiving space; and a push bar extending toward the connection module inlet from around the connection module outlet. The filter module may be inserted into the connection module after being removed from the filter case, and the push bar may push the dust outlet cover to open the dust outlet when the filter module is inserted into the connection module.

### Effects of the Invention

According to various embodiments, employing a method of pulling out of a washing-drying machine may facilitate the removal of dirt adhering to a filter mesh.

According to various embodiments, providing a filter module in a washing-drying machine may supply hot dry air to a drum without a loss of the air in a flow path as a dust outlet of the filter module is closed.

According to various embodiments, providing a filter module in a washing-drying machine may prevent dust collected in a dust collection space from being released into the surroundings as a dust outlet of the filter module is closed.

According to various embodiments, providing a filter module in a connection module may facilitate the discharge of dust collected in a dust collection space to the outside as a dust outlet of the filter module is open.

According to various embodiments, a filter module may be completely removable from a washing-drying machine, facilitating effective cleaning.

### BRIEF DESCRIPTION OF DRAWINGS

FIG. 1 is a perspective view of a washing-drying machine according to an embodiment.

FIG. 2 is a side cross-sectional view of a washing-drying machine according to an embodiment.

FIG. 3 is a perspective view of a washing-drying machine with a main body shown transparent according to an embodiment.

FIG. 4 is a perspective view of a washing-drying machine with a rear side shown according to an embodiment.

FIG. 5 is a perspective view of a filter module that may be disposed in a washing-drying machine according to an embodiment.

FIG. 6 is an exploded perspective view of a filter module that may be disposed in a washing-drying machine according to an embodiment.

FIG. 7 is a perspective view of a first filter of a filter module that may be disposed in a washing-drying machine according to an embodiment.

FIG. 8 is a perspective view of a second filter of a filter module that may be disposed in a washing-drying machine according to an embodiment.

FIG. 9 is a front view of a cleaning brush of a filter module that may be disposed in a washing-drying machine according to an embodiment.

FIG. 10 is a top view of a filter module that may be disposed in a washing-drying machine according to an embodiment.

FIG. 11 is a cross-sectional view taken along line A-A of a filter module that may be disposed in a washing-drying machine according to an embodiment.

FIG. 12 is a cross-sectional view taken along line B-B of a filter module that may be disposed in a washing-drying machine according to an embodiment.

FIG. 13 is a top view of a washing-drying machine according to an embodiment.

FIG. 14 is a schematic illustration of a state where a filter module that may be disposed in a washing-drying machine is completely inserted into the washing-drying machine according to an embodiment.

FIG. 15 is a schematic illustration of a state where a filter module that may be disposed in a washing-drying machine is partially inserted into the washing-drying machine according to an embodiment.

FIG. 16 is a schematic illustration of a state before a filter module that may be disposed in a washing-drying machine is completely removed from the washing-drying machine according to an embodiment.

FIG. 17 is a perspective view of an assembly of a filter module and a connection module according to an embodiment.

FIG. 18 is a perspective view of a connection module according to an embodiment.

FIG. 19 is a schematic illustration of an insertion relationship of a filter module, a connection module, and a cleaning device according to an embodiment.

FIG. 20 is a top view of a connection module according to an embodiment.

FIG. 21 is a cross-sectional view taken along line C-C of a connection module according to an embodiment.

FIG. 22 is a cross-sectional view taken along line C-C of an assembly of a filter module and a connection module according to an embodiment.

FIG. 23 is an enlarged view of portion D of the cross-sectional view of FIG. 22.

### BEST MODE FOR CARRYING OUT THE INVENTION

Hereinafter, embodiments of the present disclosure will be described in detail with reference to the accompanying drawings. The embodiments are not construed as limited to the disclosure and should be understood to include all changes, equivalents, and replacements within the idea and the technical scope of the disclosure.

The terms used in the embodiments are for descriptive purposes only and should not be construed as limiting. The singular forms “a,” “an,” and “the” are intended to include the plural forms as well, unless the context clearly indicates otherwise. It will be further understood that the terms “comprises/comprising” and/or “includes/including,” when used herein, specify the presence of stated features, integers, steps, operations, elements, components, accessories, and/or combinations thereof, but do not preclude the presence or addition of one or more other features, integers, steps, operations, elements, components, accessories, and/or combinations thereof.

Unless otherwise defined herein, all terms used herein including technical or scientific terms have the same meanings as those generally understood by one of ordinary skill in the art. Terms defined in dictionaries generally used should be construed to have meanings matching with contextual meanings in the related art and are not to be construed as an ideal or excessively formal meaning unless otherwise defined herein.

In addition, when describing the embodiments with reference to the accompanying drawings, like reference numerals refer to like components, even in different drawings, and a repeated description related thereto may be omitted. Also, well-known functions or constructions are not described in detail since they would obscure the description with unnecessary detail.

In addition, terms such as first, second, A, B, (a), (b), and the like may be used to describe components of the embodiments. These terms should be used only to distinguish one component from another, and the nature, sequence, or order of such components is not limited by such terms. It is to be understood that, when a component is described as “connected to,” “coupled to,” or “joining” another component, the component may be directly “connected to,” “coupled to,” or “joining” the other component, or intervening components may be present therebetween.

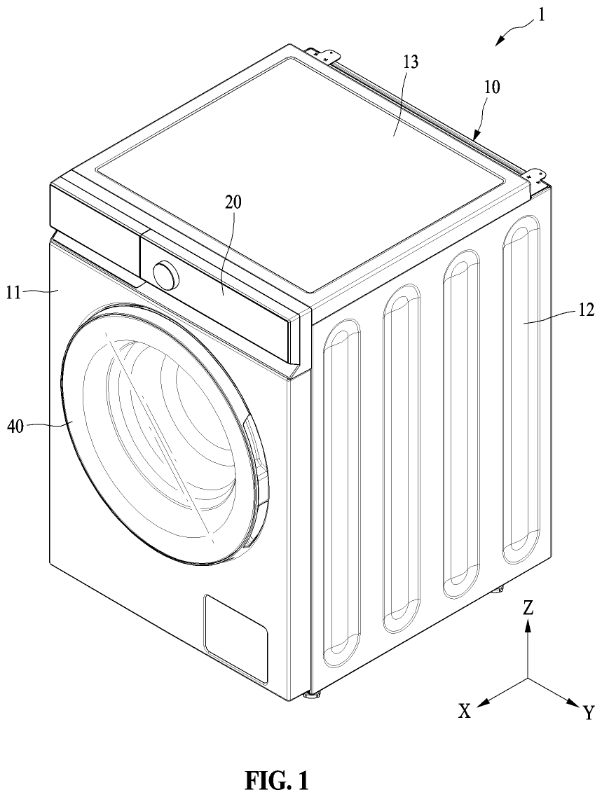

In addition, as used herein, for the term “before” or “in front of” a specific component may indicate being located or disposed in a first direction (e.g., a +x direction in FIGS. 1 to 3) with respect to the component, and the term “on” or “above” a specific component may indicate being located or disposed in a second direction (e.g., a +z direction in FIGS. 1 to 3) with respect to the component.

Components included in an embodiment may be described using the same names in other embodiments when they have the same or common features or functions. Unless otherwise indicated, the description of one embodiment applies to the other embodiments, and a detailed description thereof is omitted when it is redundant.

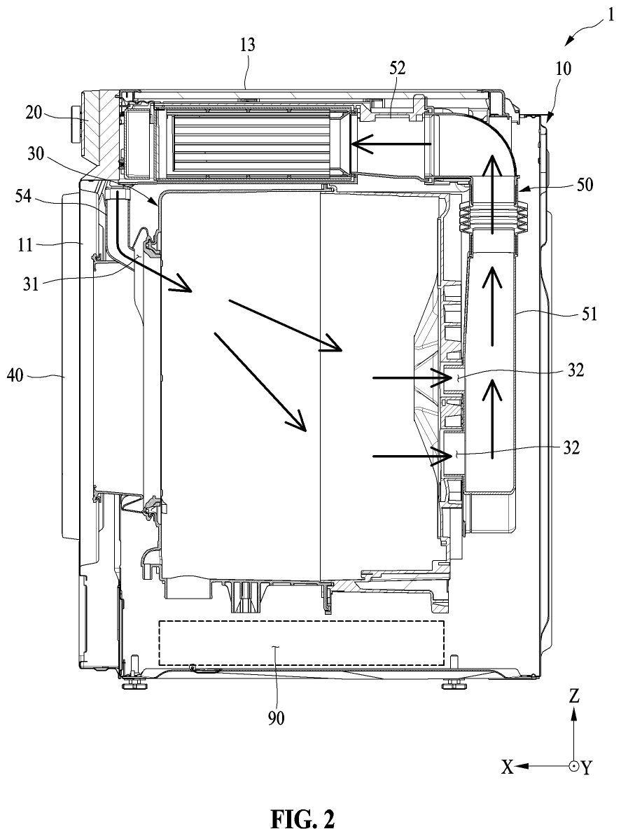

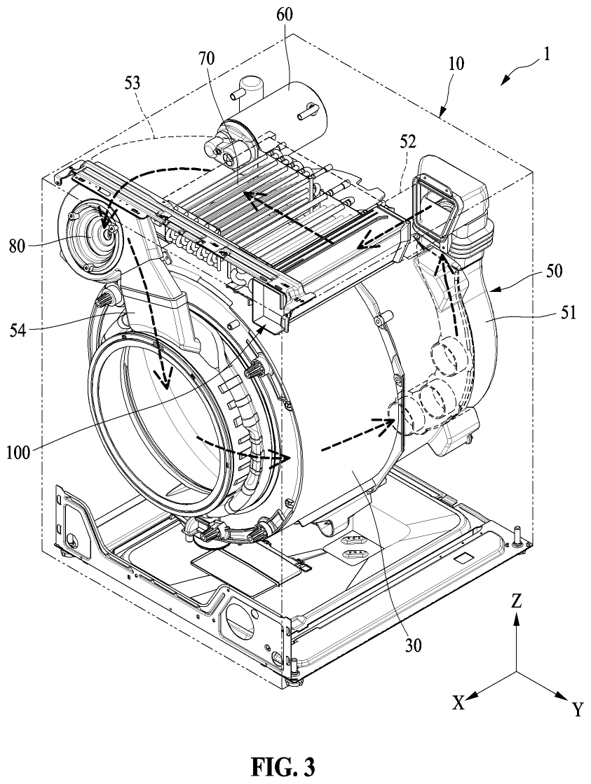

FIG. 1 is a perspective view of a washing-drying machine 1 according to an embodiment, FIG. 2 is a side cross-sectional view of the washing-drying machine 1 according to an embodiment, and FIG. 3 is a perspective view of the washing-drying machine 1 with a main body 10 shown transparent according to an embodiment. For example, the washing-drying machine 1, which is a washing machine having a drying function, may broadly include a washing device and a drying device.

Referring to FIG. 1, the washing-drying machine 1, which is a washing machine having a drying function, according to an embodiment may include the main body 10. For example, the main body 10 may include a front panel 11 disposed at the front at which a door 40 is provided, a side panel 12 disposed on each of both sides, and a top panel 13 disposed at the top.

In an embodiment, the main body 10 including the front panel 11, the side panel 12, and the top panel 13 may form the exterior of the washing-drying machine 1, and the front of the main body 10 may have a laundry inlet through which laundry is loaded into and unloaded from the main body 10. The laundry inlet may have the door 40 installed to be opened and closed. The washing-drying machine 1 may receive laundry into a drum disposed inside the main body 10 through the laundry inlet.

In an embodiment, a front upper portion of the main body 10 may have a control panel 20 on which a plurality of buttons and an input device such as a rotary lever are arranged to be operated by a user, and the user may input user commands to the washing-drying machine 1 through the control panel 20. The control panel 20 may also include a display adapted to display information related to the washing-drying machine 1 and washing and drying.

Referring to FIG. 2, the washing-drying machine 1 may include a tub 30 disposed inside the main body 10 to store water therein, the drum rotatably disposed inside the tub 30, a water supply pipe adapted to supply water to the tub 30, a drainage pipe adapted to drain water from the tub 30, a drive device adapted to rotate the drum, a circulating flow path 50, a suspension device adapted to support the tub 30, and the like.

Although the water supply pipe, the drainage pipe, the drive device, and the suspension device are not shown in FIG. 2 for simplicity of description, those having ordinary skill in the art may understand that the components provided for a laundering process may be arranged in a space 90 under the tub 30 disposed inside the washing-drying machine 1.

In addition, in an embodiment, a detergent receiving portion that may be disposed on one side in the washing-drying machine 1 may supply detergent or fabric softener to the tub 30. Specifically, when a water supply valve is open and water is supplied to the water supply pipe, the water may be provided to the detergent receiving portion to be mixed with detergent and fabric softener received in the detergent receiving portion. Accordingly, the water mixed with the detergent and the fabric softener may be supplied to the tub 30.

In an embodiment, the tub 30 may be provided inside the main body 10 of the washing-drying machine 1 and may be formed in a cylindrical shape with an opening facing the laundry inlet. The tub 30 may store a predetermined amount of water required for laundering.

In an embodiment, the drum may have a plurality of perforations formed thereon, through which laundry water inside the drum may escape and be drained to an external drainage pipe. Specifically, during a water supply administration of the washing-drying machine 1, laundry water supplied from the water supply pipe may be supplied to the inside of the tub 30 through a nozzle connected to the water supply pipe. Subsequently, during a dewatering administration of the washing-drying machine 1, the drum may be rotated at a high speed by the drive device, and the laundry water inside the drum may escape to the outside of the drum through the plurality of perforations of the drum by a centrifugal force generated from the rotation of the drum. Accordingly, the laundry water received in a space between an outer wall of the drum and an inner wall of the tub 30 may be drained to the external drainage pipe along the drainage pipe.

In an embodiment, the drum may rotate about a rotation shaft. Revolutions per minute (RPM) of the drum may vary depending on the use of the washing-drying machine 1 and the performance of a motor, but may be 1000 to 3000 RPM, for example. The motor and the rotation shaft of the drive device to rotate the drum may be installed at the rear of the tub 30.

In addition, as described above, the washing-drying machine 1 may include a drying device adapted to dry washed laundry or wet laundry. For example, it may include the circulating flow path 50, which is a passage through which air is circulated by supplying hot dry air to the drum and discharging the air used to heat the laundry and sending it back to a heat exchanger 70; the heat exchanger 70 disposed at a point inside the circulating flow path 50 and adapted to allow air to be hot and dry; a heat pump adapted to heat the heat exchanger 70 and disposed at an upper side of the inside of the washing-drying machine 1; and an air blowing fan 80 disposed at a point inside the circulating flow path 50 and adapted to generate a flow of air inside the circulating flow path 50.

The drum may receive a washing object that is a target to be washed as described above and may also receive a drying object, for example, laundry that has already been washed and dewatered. The drying object may include any object that may be dried by hot air. The drying object may include, for example, articles formed of textiles, leather, and the like, such as, clothes, towels, shoes, and the like.

Referring to FIGS. 2 and 3 together, shown is the tub 30 having an inlet 31, which is an opening through which air is drawn into the tub 30, and an outlet 32, which is an opening through which air is drawn out of the tub 30.

For example, the inlet 31 may be formed at a front upper portion of the tub 30, which may be connected to the circulating flow path 50 to receive hot dry air from the circulating flow path 50, as described below.

For example, the outlet 32 may be formed at the rear of the tub 30, which may be connected to the circulating flow path 50 to discharge air that has lost heat by heating laundry into the circulating flow path 50, as described below.

The outlet 32 may be formed as a plurality of outlets to facilitate the discharge of air.

The circulating flow path 50 may include an outlet duct 51 connected to the outlet 32 described above, a filter case 52 connected to the outlet duct 51, a heat exchange duct 53 connected to the filter case 52, and a supply duct 54 connected to the heat exchange duct 53 and the inlet 31 described above.

In the washing-drying machine 1, air may be circulated continuously in the circulating flow path 50 and the tub 30.

The outlet duct 51 may extend from the outlet 32 of the tub 30 to a rear upper portion in the main body 10. For example, since a laundering means such as the drainage pipe described above may be disposed under the tub 30, the heat exchanger 70 adapted to heat and dry air in the washing-drying machine 1 may be disposed above the tub 30, and accordingly, the outlet duct 51 may extend to the rear upper portion in the main body 10 to heat again, in the heat exchanger 70, the air that has been cooled after heating the laundry.

An upper portion of the outlet duct 51 may be connected to the filter case 52. In the filter case 52, a filter module 100 adapted to filter out debris (e.g., dust or lint) that may be contained in the air from which the laundry is dried may be inserted. The filter module 100 will be described below.

The filter case 52 may be disposed on one side or another side of an upper portion inside the main body 10. The filter case 52 may be connected to the heat exchange duct 53, and for example, air may be moved into the heat exchange duct 53 after being filtered out by the filter module 100.

When the filter case 52 is disposed on one side of the main body 10, the heat exchange duct 53 may be disposed to extend from the filter case 52 to the other side of the main body 10. Alternatively, the filter case 52 and the heat exchange duct 53 may be formed as a single duct. The distinction between the filter case 52 and the heat exchange duct 53 is intended to indicate a position of the heat exchanger 70 to be described below but does not imply that the filter case 52 and the heat exchange duct 53 need to be formed separately.

The washing-drying machine 1 may have at least one heat source, and the washing-drying machine 1 may supply air heated by the heat source to the tub 30. For example, the washing-drying machine 1 may include a condenser of the heat pump as the heat source. Additionally, a separate electric heater (not shown) may be arranged to further increase the temperature of the air supplied to the tub 30.

On the other hand, the drying device including the heat pump may be categorized into an exhaust-type dryer and a circulation-type dryer according to a flow of air circulated therein. The exhaust-type dryer refers to a drying device that draws in air from the outside of the main body 10, uses it to dry laundry, and draws it out to the outside of the main body 10. The circulation-type dryer refers to a drying device that dries laundry by continuously circulating air without drawing in or drawing out air.

The washing-drying machine 1 may include the air blowing fan 80 adapted to circulate air inside the tub 30. By the air blowing fan 80, the air inside the tub 30 may circulate in the tub 30 and the circulating flow path 50.

In the circulating flow path 50 through which the air inside the tub 30 is circulated, the heater and the heat pump may be arranged. For example, the heater and the heat pump may be provided inside the heat exchange duct 53.

The heat pump may include an expander and a compressor 60, and include the heat exchanger 70 including an evaporator and a condenser, as shown in FIG. 3.

In the compressor 60, a refrigerant in a gaseous state may be compressed into a high-temperature and high-pressure state, and the compressor 60 may then discharge a high-temperature and high-pressure gaseous refrigerant. For example, the refrigerant may be compressed in the compressor 60 through a reciprocating motion of a piston or a rotating motion of a rotor. The discharged refrigerant may be transferred to the condenser.

In the condenser, the compressed gaseous refrigerant may be condensed into a liquid. During this condensation of the refrigerant, heat may be released to the surroundings. For example, the condenser may be provided inside the heat exchange duct 53 as part of the heat exchanger 70, and may heat the surrounding air with the heat generated during the condensation of the refrigerant. The liquid refrigerant condensed in the condenser may be transferred to the expander.

The expander may expand the high-temperature and high-pressure liquid refrigerant condensed in the condenser to a low-pressure liquid refrigerant. For example, the expander may include a capillary tube adapted to regulate the pressure of the liquid refrigerant and an electronic expansion valve whose opening amount may be varied by an electrical signal.

The evaporator may evaporate the liquid refrigerant expanded in the expander and return the low-temperature and low-pressure object refrigerant to the compressor 60.

The evaporator may cool the surroundings by absorbing heat from the surroundings through such an evaporation process that changes the low-pressure liquid refrigerant into a gaseous refrigerant. For example, the evaporator may be provided inside the heat exchange duct 53 as part of the heat exchanger 70, and may cool the surrounding air during the evaporation process described above.

As the air passing around the evaporator is cooled, the dew point of the air may decrease, and water vapor present in the air by being removed from laundry during the drying of the laundry may be condensed into liquid. Such a condensation of the vapor may decrease an absolute humidity of air passing around the evaporator, and the air may become relatively drier than before passing around the evaporator. This dried air may then be fed back into the tub 30 to be used to remove water or moisture from the laundry.

On the other hand, the evaporator may be located on an upper stream than the condenser with respect to a flow of air by the air blowing fan 80, and the air that has been reduced in humidity as it passes through the evaporator may then flow into the condenser.

As described above, the condenser may release heat to its surroundings during the condensation of the refrigerant. This may allow the air around the condenser to be heated to a high temperature.

On the other hand, as described above, the washing-drying machine 1 may include the heater, and the heater may heat air by assisting the condenser. The heater may be an electric heater (e.g., a heating wire coil) that generates heat by an electric current flowing through a resistance. However, examples of the heater are not limited thereto, and various heaters may be used.

The water vapor in the air cooled by the evaporator may be condensed, and the absolute humidity in the air may thus be lowered, and the relative humidity in the air with the increased temperature by the condenser may be lowered. Therefore, the air may again receive water from the laundry.

The air that has passed through the heat exchanger 70 including the evaporator and the condenser located within the heat exchange duct 53 may be fed back to the inlet 31 of the tub 30 via the supply duct 54 connected to the heat exchange duct 53.

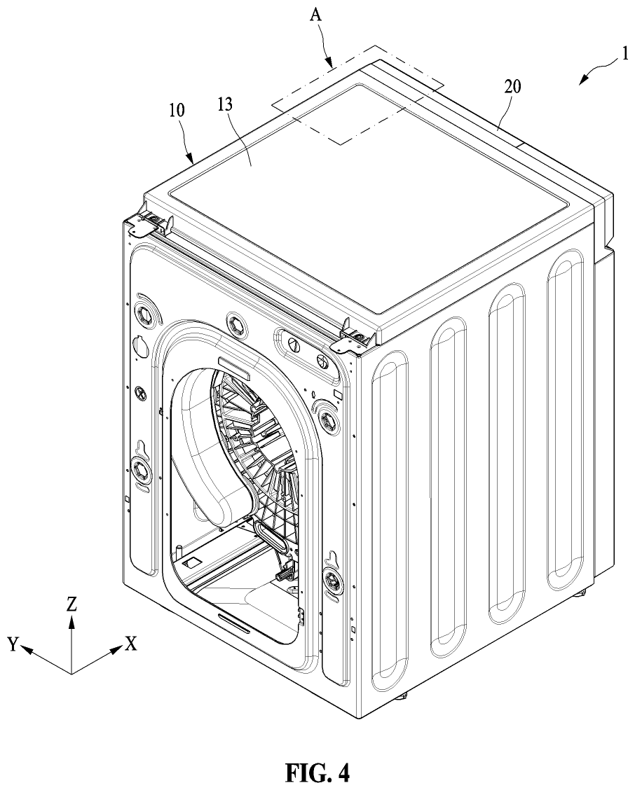

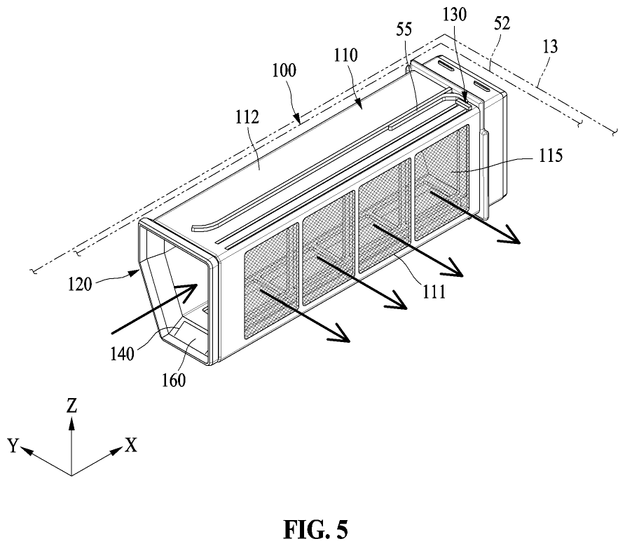

FIG. 4 is a perspective view of the washing-drying machine 1 with a rear side thereof shown according to an embodiment, and FIG. 5 is a perspective view of the filter module 100 that may be disposed in the washing-drying machine 1 according to an embodiment. FIG. 5 is an enlarged view of portion A of FIG. 4 with other components (e.g., the top panel 13, the filter case 52, etc.) therearound not shown. Accordingly, FIG. 5 shows an orientation of the filter module 100 when inserted into the filter case 52 of the washing-drying machine 1.

As shown in FIG. 5, the filter module 100 may be inserted into the filter case 52 to act as a part of a flow path. Air flowing into the filter module 100 may pass through the filter module 100 to be filtered and may then be discharged to the outside of the filter module 100. Through this filter module 100, dirt or dust in the air circulating through a circulating flow path (e.g., the circulating flow path 50 in FIG. 2) may be filtered out.

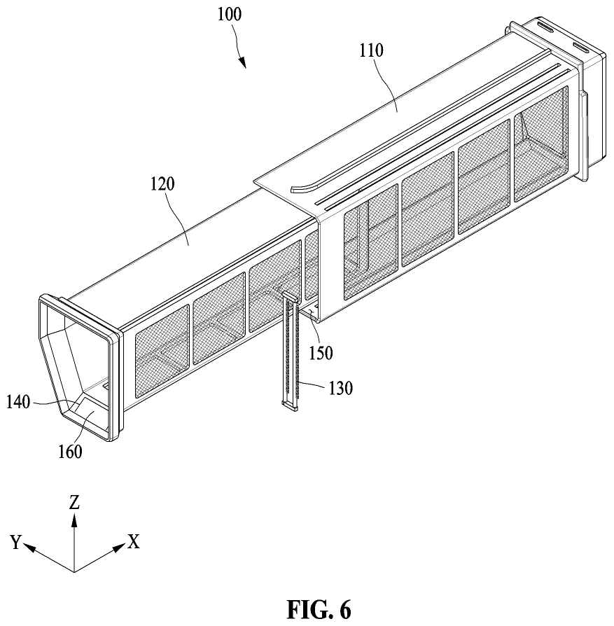

FIG. 6 is an exploded perspective view of the filter module 100 that may be disposed in the washing-drying machine 1 according to an embodiment.

The filter module 100 may include a first filter 110 in which a first filter mesh 115 is formed; a second filter 120 in which a second filter mesh 125 is formed, which is at least partially or fully received in the first filter 110; a cleaning brush 130 adapted to clean the first filter mesh 115 and the second filter mesh 125; a dust outlet 140 formed at one end of the second filter 120; and a dust outlet cover 160 covering the dust outlet 140.

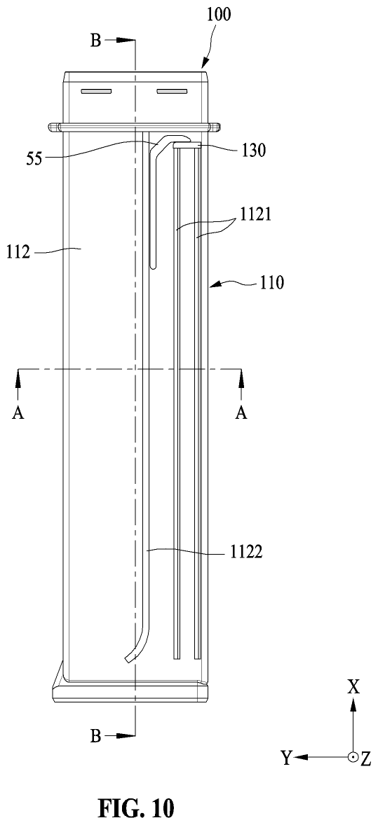

When the first filter 110 and the second filter 120 are coupled, a dust collection space (e.g., a dust collection space 150 in FIG. 10) may be formed between the first filter 110 and the second filter 120, which is not shown in FIG. 5 because FIG. 5 shows only a state where the first filter 110 and the second filter 120 are separated, and this will be described below.

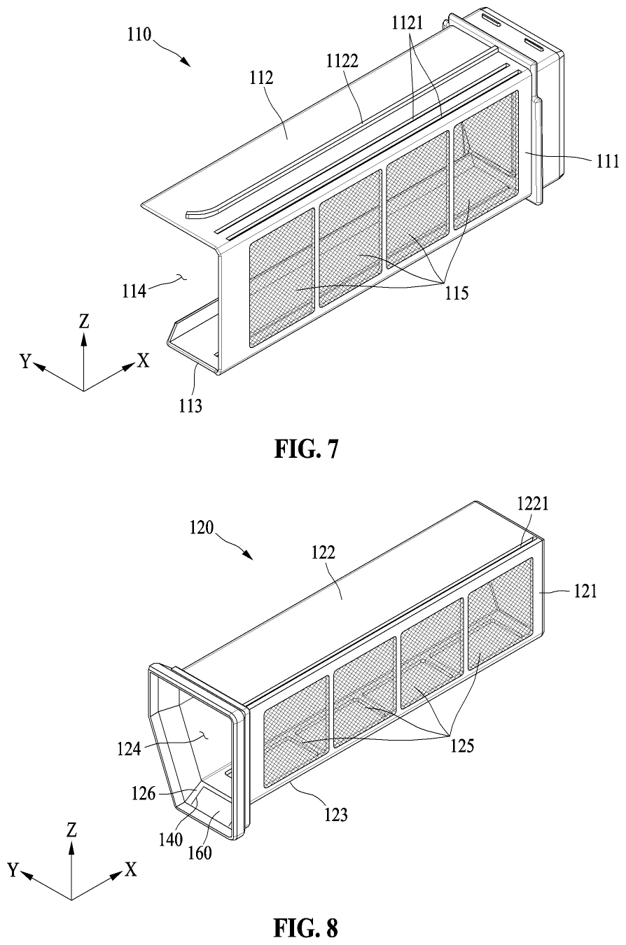

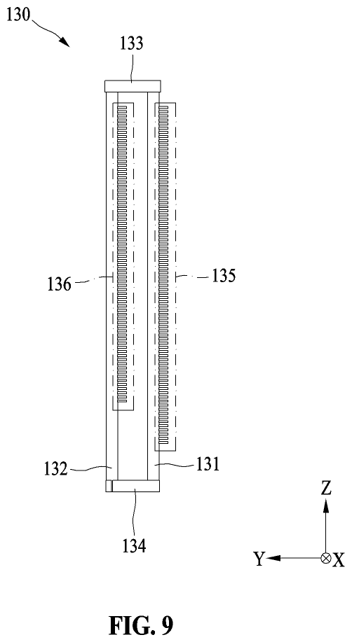

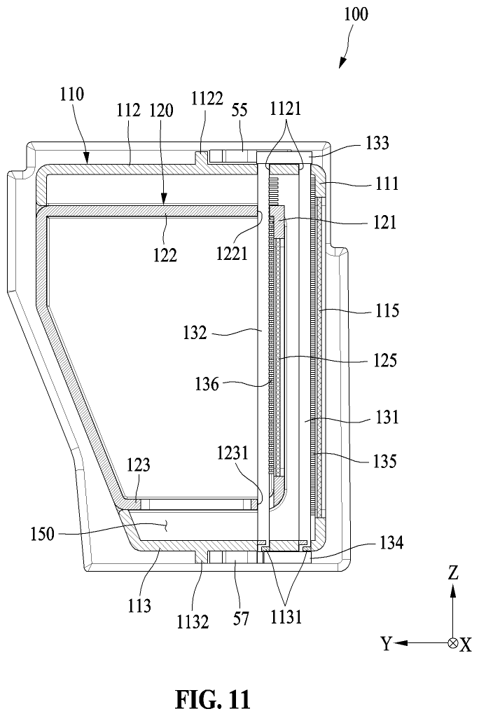

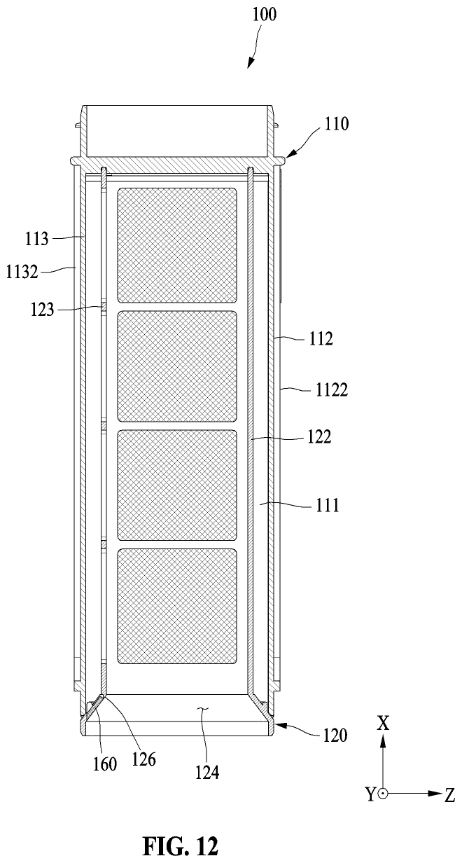

FIG. 7 is a perspective view of the first filter 110 of the filter module 100 that may be disposed in the washing-drying machine 1 according to an embodiment, FIG. 8 is a perspective view of the second filter 120 of the filter module 100 that may be disposed in the washing-drying machine 1 according to an embodiment, FIG. 9 is a front view of the cleaning brush 130 of the filter module 100 that may be disposed in the washing-drying machine 1 according to an embodiment, FIG. 10 is a top view of the filter module 100 that may be disposed in the washing-drying machine 1 according to an embodiment, FIG. 11 is a cross-sectional view taken along line A-A of the filter module 100 that may be disposed in the washing-drying machine 1 according to an embodiment, and FIG. 12 is a cross-sectional view taken along line B-B of the filter module 100 that may be disposed in the washing-drying machine 1 according to an embodiment.

Referring to FIG. 7, the first filter 110 may be open on one side such that the first filter 110 may have a first filter inlet 114. Referring to FIG. 8, the second filter 120 may include a second filter inlet 124 that opens in the same direction as the first filter inlet 114 in a state where it is received in the first filter 110. Air may be drawn into an inlet of the filter module 100, for which the first filter inlet 114 or the second filter inlet 124 is provided as an example.

Referring again to FIG. 7, the first filter 110 may include a first filter mesh face 111 perpendicular to one open side on which the first filter inlet 114 is formed. On the first filter mesh face 111, the first filter mesh 115 may be formed.

The first filter mesh 115 may be formed as a single mesh throughout the entire area of the first filter mesh face 111, or may be separated into a plurality of partial meshes and arranged on the first filter mesh face 111 as shown in FIG. 7. Air flowing into the first filter inlet 114 may be discharged from the inside of the first filter 110 to the outside of the first filter 110, for example, in a first direction (e.g., a −y direction in FIGS. 7 to 15).

The first filter 110 may also include a first filter first face 112 perpendicular to one surface on which the first filter inlet 114 is formed and to the first filter mesh face 111, and may also include a first filter second face 113 disposed opposite the first filter first face 112. Referring to FIG. 7, the first filter first face 112, the first filter mesh face 111, and the first filter second face 113 may be arranged in a “⊏” shape in which a left side and a right side are inverted.

The first filter first face 112, the first filter mesh face 111, and the first filter second face 113 may extend to be elongated in a second direction (e.g., a +x direction in FIGS. 7 to 15).

On the other hand, the opposite side of the first filter mesh surface 111 of the first filter 110 may be open. However, the shape of the first filter 110 is not limited thereto, and the opposite side of the first filter mesh face 111 may not be open. In a case where the opposite side of the first filter mesh face 111 is open, the second filter 120 may be at least partially received in the first filter 110 through an open portion of the first filter inlet 114 and/or the opposite side of the first filter mesh face 111.

In addition, the first filter first face 112 may have a first filter first face slit 1121 extending in the second direction from around the first filter inlet 114 and, referring to FIG. 11 together, the first filter second face 113 may have a first filter second face slit 1131 extending in the second direction from around the first filter inlet 114 in the same way as a slit is formed on the first filter first face 112.

The first filter first face slit 1121 and the first filter second face slit 1131 may be formed as a double slit in which the cleaning brush 130 may be received, as described below.

Referring to FIG. 11, a portion of the first filter second face slit 1131 may have a portion that overlaps the cleaning brush 130. At least a portion of this overlapping portion may be formed of an elastic material (e.g., rubber) and may allow the cleaning brush 130 to maintain its position relative to the first filter 110.

Referring again to FIG. 7, a first filter first face guide rib 1122, which is formed to be spaced apart from the first filter first face slit 1121 in an opposite direction of the first direction, may be provided on the first filter first face 112.

Similarly, referring to FIGS. 11 and 12 together, a first filter second face guide rib 1132, which is formed to be spaced apart from the first filter second face slit 1131 in the opposite direction of the first direction, may be provided on the first filter second face 113.

The first filter first face guide rib 1122 and the first filter second face guide rib 1132 may support fastening portions (e.g., a first fastening portion 55 in FIG. 10 and a second fastening portion 57) in the first direction, as described below.

Referring again to FIG. 7, the first filter first face guide rib 1122 may be bent around the first filter inlet 114 to face in the opposite direction of the first direction, and similarly, the first filter second face guide rib 1132 may be bent around the first filter inlet 114 to face in the opposite direction of the first direction.

Referring to FIG. 8, the overall shape of the second filter 120 is shown. As shown in the first filter 110, the second filter 120 may be open on one side such that the second filter 120 may have the second filter inlet 124. The open side of the second filter 120 on which the second filter inlet 124 is disposed may be formed by being open in the same direction as the open side of the first filter 110 on which the first filter inlet 114 is disposed.

The second filter 120 may include a second filter mesh face 121 perpendicular to the open side on which the second filter inlet 124 is formed. The second filter mesh face 121 may have a second filter mesh 125 formed thereon.

The second filter mesh 125 may be formed as a single mesh throughout the entire area of the second filter mesh face 121, or may be separated into a plurality of partial meshes and arranged on the second filter mesh face 121 as shown in FIG. 8. Air flowing into the second filter inlet 124 may be discharged from the inside of the second filter 120 to the outside of the second filter 120, for example, in the first direction.

In addition, the second filter 120 may include a second filter first face 122 perpendicular to the one side on which the second filter inlet 124 is formed and to the second filter mesh face 121; and a second filter second face 123 disposed opposite the second filter first face 122. The second filter 120 may also include a face disposed opposite the second filter mesh face 121.

The first filter first face 112, the first filter mesh face 111, the first filter second face 113, and the face opposite the second filter mesh face 121 may be disposed in a squashed “□” shape.

The faces of the second filter 120 described above may extend to be elongated along the second direction.

In addition, referring to FIGS. 8 and 5 together, in a state of the filter module 100 with the first filter 110 and the second filter 120 coupled, a second filter inclined face 126, which extends to be inclined toward an end of the first filter second face 113 around the first filter inlet 114, may be formed at an end of the second filter second face 123 around the second filter inlet 124.

Referring to FIG. 11, the second filter second face 123 may be spaced apart from the first filter second face 113 to face the second filter second face 123, and this spacing may form the dust collection space 150 between the second filter second face 123 and the first filter second face 113.

Referring to FIG. 12 together, the second filter inclined face 126 may prevent the dust collection space 150 from being open to the outside of the filter module 100 on the side of the first filter inlet 114.

Referring again to FIG. 8, the dust outlet 140 may be formed on the second filter inclined face 126, and the dust outlet cover 160 may be formed on the dust outlet 140 to cover the dust outlet 140.

The dust collection space 150 described above may be a space in which dust separated from the first filter mesh 115 and the second filter mesh 125 is collected, and may selectively communicate with the outside of the filter module 100 to allow the collected dust to be discharged to the outside. To this end, the dust outlet 140 formed on the second filter inclined face 126 may be selectively opened or closed by the dust outlet cover 160.

The form and shape of the dust outlet 140 and the dust outlet cover 160 may vary. For example, the dust outlet 140 may be formed as at least a portion of the second filter inclined face 126 is open. In addition, for example, one side of the dust outlet cover 160 may be connected to a corner that is proximate to the first filter second face 113 among corners of the dust outlet 140.

For example, the dust outlet cover 160 may be formed of an elastic member (e.g., rubber and a highly flexible plastic member) such that, when a force is applied to the dust outlet cover 160 in the second direction, it is rotated about the fixed one side to open the dust outlet 140. Subsequently, when the force applied to the dust outlet cover 160 is removed, the dust outlet cover 160 may return to its original position to close the dust outlet 140.

For example, a portion where the dust outlet 140 and the dust outlet cover 160 are connected to each other may be formed as a hinge structure. In such a connecting portion, a spring may be disposed. As in the case described above, the dust outlet 140 may be open when a force is applied to the dust outlet cover 160 in the second direction, and the dust outlet 140 may be closed when the force is removed.

Referring to FIG. 9, the cleaning brush 130 included in the filter module 100 is shown in detail according to an embodiment.

The cleaning brush 130 may include a first brush member 131 and a second brush member 132 extending in parallel in a third direction (e.g., a +z direction in FIGS. 7 to 15). Here, ends of the first brush member 131 and the second brush member 132 toward the third direction may be connected by a first face side connecting portion 133, and ends of the first brush member 131 and the second brush member 132 toward an opposite direction of the third direction may be connected by a second face side connecting portion 134.

The first brush member 131, the second brush member 132, the first face side connecting portion 133, and the second face side connecting portion 134 may be implemented as a square ring in a “□” shape, but the shape they form may vary without being limited to the shape described above.

The first brush member 131 may have a first brush member brushing area 135 formed to clean dirt or dust from the first filter mesh 115, and the second brush member 132 may have a second brush member brushing area 136 formed to clean dirt or dust from the second filter mesh 125.

Referring to FIG. 11, a positional relationship of the cleaning brush 130 with respect to the first filter 110 and the second filter 120 is shown.

The first brush member 131 may be disposed between the first filter 110 and the second filter 120 and may contact an inner side of the first filter mesh 115 (e.g., a portion facing the opposite direction of the first direction). The second brush member 132 may contact an inner side of the second filter mesh 125 (e.g., a portion facing the opposite direction of the first direction).

The first brush member brushing area 135 may be formed to be longer than a length of the first filter mesh 115 along the third direction to clean an entire area of the first filter mesh 115, and the second brush member brushing area 136 may be formed to be longer than a length of the second filter mesh 125 along the third direction to clean an entire area of the second filter mesh 125.

Since the first filter 110 may be received in the second filter 120, the length of the second filter mesh 125 along the third direction may be shorter than the length of the first filter mesh 115 along the third direction, and accordingly, the length of the second brush member brushing area 136 along the third direction may be shorter than the length of the first brush member brushing area 135 along the third direction.

The first brush member 131 may extend through the first filter first face slit 1121 and the first filter second face slit 1131, and the second brush member 132 may extend through the first filter first face slit 1121, the second filter first face slit 1221, the second filter second face slit 1231, and the first filter second face slit 1131.

The first face side connecting portion 133 may be disposed on an outer side of the first filter first face 112, and the second face side connecting portion 134 may be disposed on an outer side of the first filter second face 113.

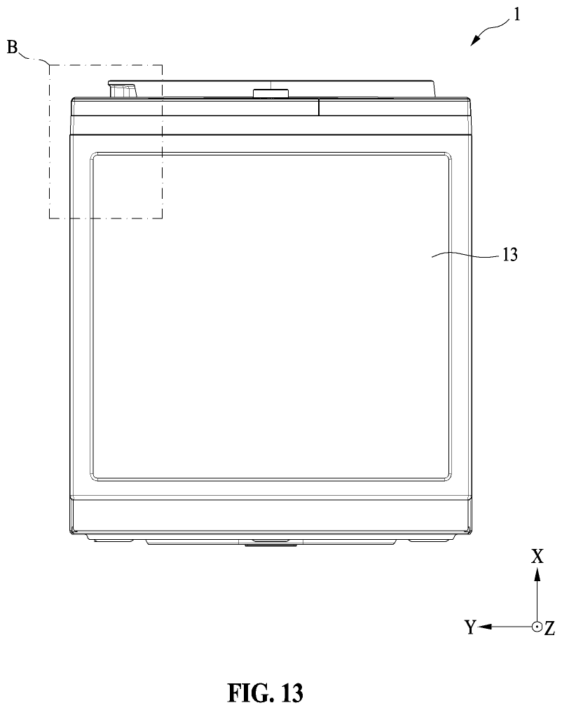

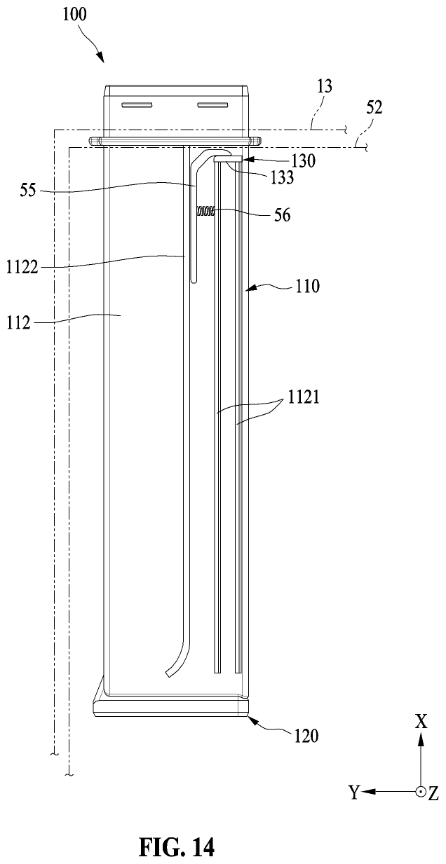

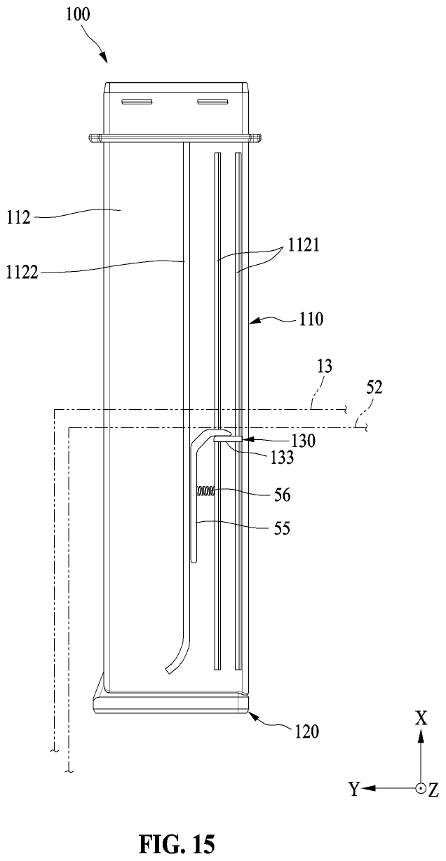

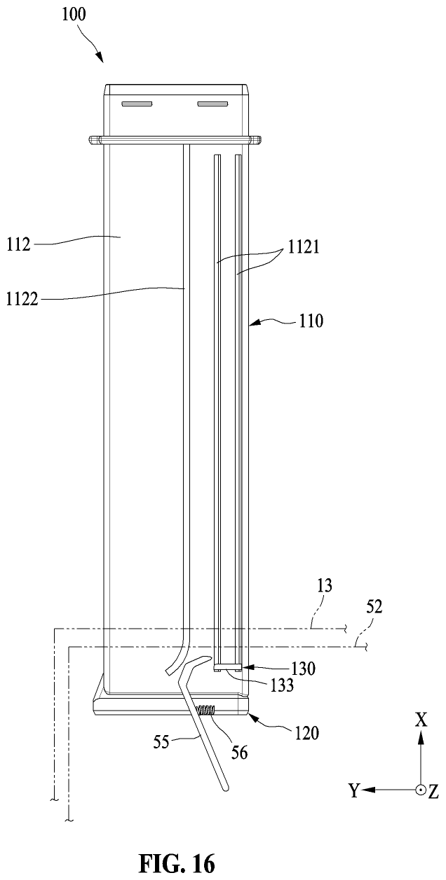

FIG. 13 is a top view of the washing-drying machine 1 according to an embodiment, FIG. 14 schematically illustrates a state where the filter module 100 that may be disposed in the washing-drying machine 1 is completely inserted into the washing-drying machine 1 by enlarging portion B of FIG. 13 according to an embodiment, FIG. 15 schematically illustrates a state where the filter module 100 that may be disposed in the washing-drying machine 1 is partially inserted into the washing-drying machine 1 by enlarging the portion B of FIG. 13 according to an embodiment, and FIG. 16 schematically illustrates a state before the filter module 100 that may be disposed in the washing-drying machine 1 is completely removed or detached from the washing-drying machine 1 by enlarging the portion B of FIG. 13 according to an embodiment.

Referring to FIG. 14, the top panel 13 of the main body 10 and the filter case 52 are schematically shown, and the filter module 100 fully inserted into the filter case 52 is shown. The first fastening portion 55 supported by the first filter first face guide rib 1122 on one side, and a first spring 56 of which one side is supported by one point within the filter case 52 and another side is supported by the first fastening portion 55 are also shown.

The first fastening portion 55 may be provided in an L shape. A portion of the first fastening portion 55 along the first direction may contact the first face side connecting portion 133. This portion may be disposed in the first direction of the first face side connecting portion 133 and may thus restrict the cleaning brush 130 from moving in the first direction.

Referring to FIG. 15, a movement of the cleaning brush 130 along the first direction may be restricted by the first fastening portion 55, and the cleaning brush 130 may thus be displaced with respect to the filter module 100. The cleaning brush 130 that is relatively displaced with respect to the filter module 100 may slide in all slits within the first filter 110 of the filter module 100 including the first filter first face slit 1121.

Since the cleaning brush 130 may be in contact with a filter mesh (e.g., the first filter mesh 115 and the second filter mesh 125 in FIG. 11) of the filter module 100 as described above, the cleaning brush 130 may remove dirt adhering to an inner side of the filter mesh while being relatively displaced with respect to the filter module 100. This may allow a simple process of withdrawing the filter module 100 from the washing-drying machine 1 to remove dirt adhering to the inner side of the filter mesh, without having to perform cleaning by removing the filter module 100 from the washing-drying machine 1 and disassembling the filter module 100.

In addition, referring to FIG. 16, a state where the first face side connecting portion 133 is not restricted by the first fastening portion 55 is shown. As described above, the first filter first face guide rib 1122 may be formed to be partially bent, and one side of the first fastening portion 55 may be supported by the first filter first face guide rib 1122. Thus, an orientation of the first fastening portion 55 may be changed at the bent portion.

Since one side of the first spring 56 is fixed at one point of the filter case 52 and another side thereof is supported by the first fastening portion 55, the first spring 56 may be in a compressed state in the orientation of the fastening portion 55 shown in FIGS. 14 and 15.

When the first filter first face guide rib 1122 fails to support the first fastening portion 55 on one side as shown in FIG. 16, the first spring 56, which was in the compressed state, may be deployed, and in this case, the first fastening portion 55 may no longer restrict the displacement of the first face side connecting portion 133 in the first direction.

Subsequently, since the displacement of the first face side connecting portion 133 is not restricted, the filter module 100 may be displaced in the first direction together with the cleaning brush 130 and removed from the washing-drying machine 1.

The selective restriction by the first fastening portion 55 as described above may provide the following advantages. When it is restricted, the cleaning brush 130 may be relatively displaced with respect to the filter module 100 to clean the first filter mesh 115 and the second filter mesh 125. When it is not restricted, the cleaning brush 130 may be removed from the washing-drying machine 1 together with the filter module 100, allowing the user to disassemble and clean the filter module 100 themselves.

A relationship between the second fastening portion 57, a second spring, the first filter second face guide rib 1132, and the second face side connecting portion 134 is the same as the relationship between the first fastening portion 55, the first spring 56, the first filter first face guide rib 1122, and the first face side connecting portion 133 described above, and thus a more detailed description thereof is omitted within the same scope for simplicity of description.

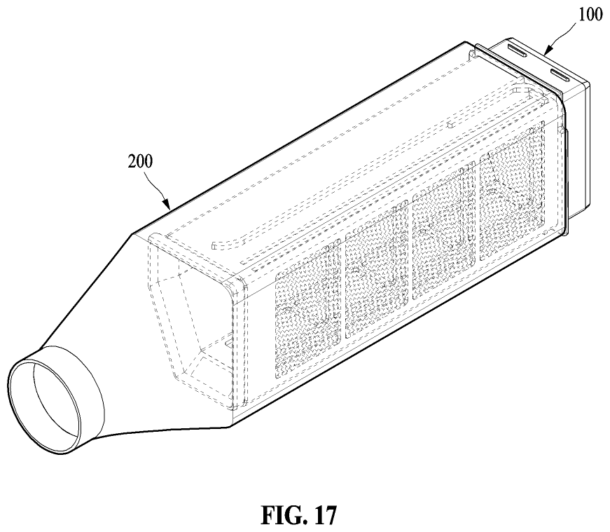

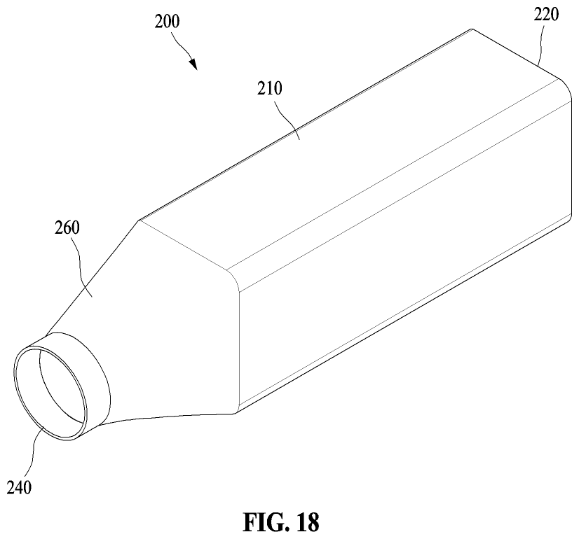

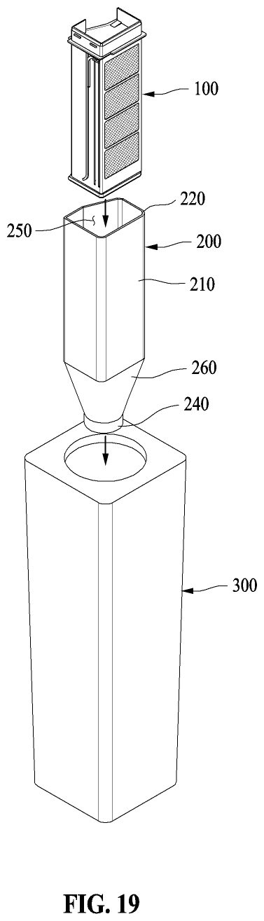

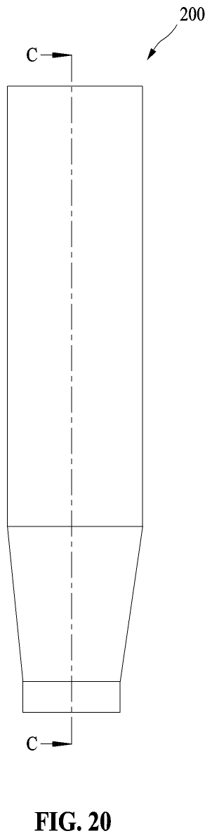

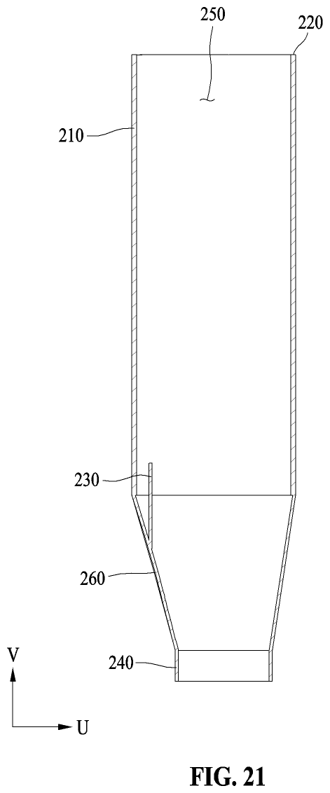

FIG. 17 is a perspective view of an assembly of a filter module and a connection module according to an embodiment, FIG. 18 is a perspective view of a connection module 200 according to an embodiment, FIG. 19 is a schematic illustration of an insertion relationship of the filter module 100, the connection module 200, and a cleaning device 300 according to an embodiment, FIG. 20 is a top view of the connection module 200 according to an embodiment, and FIG. 21 is a cross-sectional view taken along line C-C of the connection module 200 according to an embodiment.

According to an embodiment, as the filter module 100 is inserted into the connection module 200, an assembly of the filter module 100 and the connection module 200 may be provided.

Referring to FIG. 19, the connection module 200 may be a medium between the filter module 100 and the cleaning device 300 (e.g., a vacuum cleaning device 300) to remove dirt or dust collected in the dust collection space 150 (e.g., the dust collection space 150 in FIG. 11) of the filter module 100 via the cleaning device 300.

For example, the dust outlet 140 of the filter module 100 may be open to allow the dust collection space 150 to communicate with the cleaning device 300.

The connection module 200 may include a connection module body 210, a receiving space 250 formed inside the connection module body 210 such that at least a portion of the filter module 100 is inserted therein, a connection module inlet 220 formed at one end of the connection module body 210 and connected to the receiving space 250, and a connection module outlet 240 formed at another end of the connection module body 210 and connected to the receiving space 250.

In addition, the connection module 200 may include a connection module inclined face 260 of which a portion around the connection module outlet 240 of the connection module body 210 is formed to be inclined, and thus the size of the connection module outlet 240 may be smaller than the size of the connection module inlet 220. In addition, a push bar 230 may be formed to extend in a direction from the connection module outlet 240 toward the connection module inlet 220 in the connection module inclined face 260.

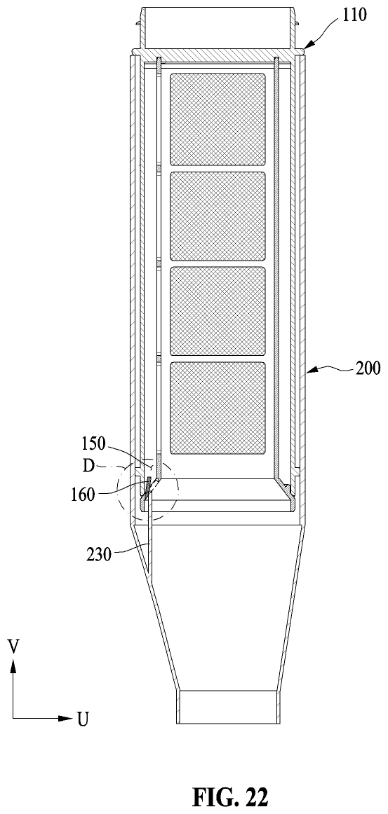

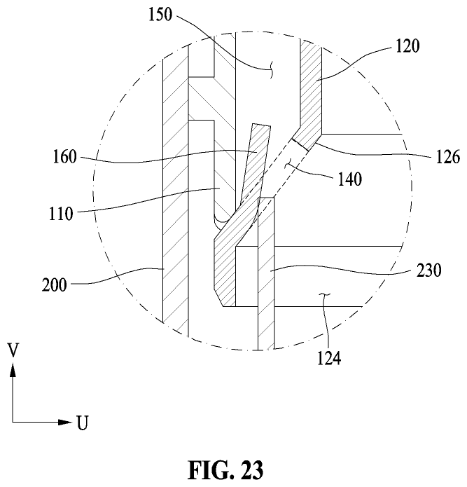

FIG. 22 is a cross-sectional view taken along line C-C of the assembly of the filter module 100 and the connection module 200 according to an embodiment, and FIG. 23 is an enlarged view of portion D of the cross-sectional view of FIG. 22.

When the filter module 100 is received in the connection module 200, the push bar 230 of the connection module 200 may overlap the dust outlet cover 160. In this case, the dust outlet cover 160 may be bent in a first direction (e.g., a +v direction in FIG. 22), and the dust outlet 140 may be open.

In a case where, as described above, the dust outlet cover 160 is formed of an elastic member or is connected to the second filter inclined face 126 through a hinge structure, the overlap may allow the dust outlet cover 160 to be bent, and when the filter module 100 is then removed from the connection module 200, the overlap between the dust outlet cover 160 and the push bar 230 may be released, allowing the dust outlet cover 160 to return to its position.

When the dust outlet 140 is open by the overlap, the dust collection space 150 may communicate with a cleaning device (e.g., the cleaning device 300 in FIG. 19) via the connection module 200, and dust in the dust collection space 150 may be removed by the cleaning device 300.

According to various embodiments, a washing machine having a drying function, or a washing-drying machine 1, may include: a main body 10 having a laundry inlet provided at the front; a tub 30 disposed inside the main body 10 to store water therein; a drum rotatably disposed inside the tub 30; a heat exchanger 70 disposed above the tub 30 and adapted to heat air supplied into the tub 30; an air blowing fan adapted to form a circulating flow path 50 that passes through the tub 30 and the heat exchanger 70; a filter case 52 having a filter case inlet of the filter case 52 provided at the rear such that air discharged from the tub 30 flows in and a filter case outlet of the filter case 52 provided at the side such that air is supplied to the heat exchanger 70; and a filter module 100 disposed to be received in the inside of the filter case 52 or withdrawn to the outside of the filter case 52. The filter module 100 may include: a filter mesh facing the filter case outlet of the filter case 52 when the filter module 100 is received in the inside of the filter case 52; and a cleaning brush 130 adapted to sweep the filter mesh to separate foreign substances caught in the filter mesh when the filter module 100 is withdrawn from the filter case 52.

In various embodiments, the filter mesh may include a first filter mesh 115 and a second filter mesh 125 formed to be spaced apart, and the filter module 100 may include: a first filter 110 including a first filter inlet 114 formed toward the filter case inlet of the filter case 52; a second filter 120, at least a portion of which is received in the first filter 110, including a second filter inlet 124 formed toward the filter case inlet of the filter case 52; a dust collection space 150 formed between the first filter 110 and the second filter 120; a dust outlet 140 formed around the first filter inlet 114 and connecting the dust collection space 150 and the outside of the first filter 110; and a dust outlet cover 160 covering the dust outlet 140.

In various embodiments, the first filter 110 may include: a first filter mesh face 111 on which the first filter mesh 115 is formed; a first filter first face 112 coupled to one side of the first filter mesh face 111; and a first filter second face 113 coupled to another side of the first filter mesh face 111. The second filter 120 may include: a second filter mesh face 121 on which the second filter mesh 125 is formed; a second filter first face 122 coupled to one side of the second filter mesh face 121; and a second filter second face 123 coupled to another side of the second filter mesh face 121. The first filter mesh face 111 may be disposed to face the outside of the second filter 120 from the second filter mesh face 121, in a first direction perpendicular to the second filter mesh face 121. The second filter first face 122 may be disposed to face the first filter second face 113 from the first filter first face 112. The second filter second face 123 may be disposed to face the first filter first face 112 from the first filter second face 113. At an end of the second filter second face 123 toward the second filter inlet 124, a second filter inclined face 126 that extends to be inclined toward an end of the first filter second face 113 toward the first filter inlet 114 and is connected to the end of the first filter second face 113 may be formed. The dust outlet 140 and the dust outlet cover 160 may be disposed on the second filter inclined face 126.

In various embodiments, at least a portion of the cleaning brush 130 may be disposed between the first filter mesh face 111 and the second filter mesh face 121.

In various embodiments, the cleaning brush 130 may be provided in the form of a square ring, and the cleaning brush 130 may include: a first brush member 131 disposed between the first filter mesh face 111 and the second filter mesh face 121; and a second brush member 132 disposed in an opposite direction of the first direction from the second filter mesh face 121.

In various embodiments, the first filter first face 112 may have a first filter first face slit 1121 formed to extend in an opposite direction from the first filter inlet 114. The first filter second face 113 may have a first filter second face slit 1131 formed to extend in the opposite direction from the first filter inlet 114. The second filter first face 122 may have a second filter first face slit 1221 formed to extend in an opposite direction from the second filter inlet 124. The second filter second face 123 may have a second filter second face slit 1231 formed to extend in the opposite direction from the second filter inlet 124. The first filter first face slit 1121 and the first filter second face slit 1131 may be a double slit. The first brush member 131 may extend through one slit portion of the first filter first face slit 1121 and one slit portion of the first filter second face slit 1131. The second brush member 132 may extend through a remaining slit portion of the first filter first face slit 1121, a remaining slit portion of the first filter second face slit 1131, the second filter first face slit 1221, and the second filter second face slit 1231.

In various embodiments, the cleaning brush 130 may further include: a first face side connecting portion 133 that connects a portion extending from the first brush member 131 through the first filter first face 112 and a portion extending from the second brush member 132 through the first filter first face 112; and a second face side connecting portion 134 that connects a portion extending from the first brush member 131 through the first filter second face 113 and a portion extending from the second brush member 132 through the first filter second face 113.

In various embodiments, a length of a brush area 135 formed on the first brush member 131 may be greater than or equal to a length of the first filter mesh 115 along an extension direction of the first brush member 131, and a length of a brush area 136 formed on the second brush member 132 may be greater than or equal to a length of the second filter mesh 125 along an extension direction of the second brush member 132.

In various embodiments, the first filter 110 may further include: a first filter first face guide rib 2233 formed on the first filter first face 112, spaced apart from the first filter first face slit 1121; and a first filter second face guide rib 1132 formed on the first filter second face 113, spaced apart from the first filter second face slit 1131.

In various embodiments, the first filter first face guide rib 1122 may bend in an opposite direction of the first direction at a side of the first filter inlet 114, and the first filter second face guide rib 1132 may bend in the opposite direction of the first direction at the side of the first filter inlet 114.

In various embodiments, the washing-drying machine 1 may further include a connection module 200. The connection module 200 may include: a connection module body 210; a receiving space 250 formed inside the connection module body 210 into which at least a portion of the first filter 110 is to be inserted; a connection module inlet 220 formed at one end of the connection module body 210 and connected to the receiving space 250; a connection module outlet 240 formed at another end of the connection module body 210 and connected to the receiving space 250; and a push bar 230 extending toward the connection module inlet 220 from around the connection module outlet 240. When the filter module 100 is inserted into the connection module 200, the push bar 230 may be adapted to push the dust outlet cover 160 to open the dust outlet 140.

In various embodiments, the connection module 200 may include: a connection module inclined face 260 formed to be inclined on a portion around the connection module outlet 240 of the connection module body 210, such that the connection module outlet 240 is smaller than the connection module inlet 220. The push bar 230 may be disposed on the connection module inclined face 260.

In various embodiments, the dust outlet cover 160 may be adapted to be resilient and not to impede a movement of the push bar 230 even in the event of interference with the push bar 230.

In various embodiments, the dust outlet cover 160 may include a hinge structure on one side thereof, and the hinge structure may include a spring.

According to various embodiments, a washing-drying machine 1 using a filter module 100 insertable into a filter connection module 200 may include: a main body 10 having a laundry inlet provided at the front; a tub 30 disposed inside the main body 10 to store water therein; a drum rotatably disposed inside the tub 30; a heat exchanger 70 disposed above the tub 30 and adapted to heat air supplied into the tub 30; an air blowing fan adapted to form a circulating flow path 50 that passes through the tub 30 and the heat exchanger 70; a filter case 52 having a filter case inlet of the filter case 52 provided at the rear such that air discharged from the tub 30 flows in and a filter case outlet of the filter case 52 provided at the side such that air is supplied to the heat exchanger 70; and the filter module 100 disposed to be received in the inside of the filter case 52 or withdrawn to the outside of the filter case 52. The tub 30 may include an outlet at a rear lower side and an inlet at a front upper side. The circulating flow path 50 may include: an outlet duct connected to the outlet and extending from the rear lower side of the tub 30 to one side of a rear upper portion in the main body 10; the filter case 52 connected to the outlet duct and extending from one side of the rear upper portion in the main body 10 to one side of a front upper portion in the main body 10; a heat exchange duct connected to the filter case 52 and extending from one side of the front upper portion in the main body 10 to another side; and a supply duct connected to the heat exchange duct and connected to the inlet. The filter module 100 may be inserted into a filter insertion portion provided within the filter case 52, and the filter module 100 may include: a first filter 110 including a first filter inlet 114 formed toward the filter case inlet of the filter case 52 and including a first filter mesh 115 formed to face the filter case outlet of the filter case 52 when the filter module 100 is received in the inside of the filter case 52; a second filter 120 including a second filter inlet 124 formed toward the filter case inlet of the filter case 52 and including a second filter mesh 125 formed to face the first filter mesh 115, with at least a portion thereof being received in the first filter 110; a dust collection space 150 formed between the first filter 110 and the second filter 120; a dust outlet 140 formed around the first filter inlet 114 and connecting the dust collection space 150 and the outside of the first filter 110; and a dust outlet cover 160 covering the dust outlet 140. Air in the filter case 52 may enter the first filter inlet 114 and pass through the second filter mesh 125 and the first filter mesh 115 to move into the heat exchange duct.

In various embodiments, the filter module 100 may be insertable into the connection module 200 after being removed from the filter case 52. The connection module 200 may include: a connection module body 210; a receiving space 250 formed inside the connection module body 210 into which at least a portion of the first filter 110 is to be inserted; a connection module inlet 220 formed at one end of the connection module body 210 and connected to the receiving space 250; a connection module outlet 240 formed at another end of the connection module body 210 and connected to the receiving space 250; and a push bar 230 extending toward the connection module inlet 220 from around the connection module outlet 240. The push bar 230 may push the dust outlet cover 160 to open the dust outlet 140 when the filter module 100 is inserted into the connection module 200.

In various embodiments, the first filter 110 may include: a first filter mesh face 111 on which the first filter mesh 115 is formed; a first filter first face 112 perpendicular to the first filter inlet 114 and the first filter mesh face 111; and a first filter second face 113 disposed opposite the first filter first face 112. The second filter 120 may include: a second filter mesh face 121 on which the second filter mesh 125 is formed; a second filter first face 122 perpendicular to the second filter inlet 124 and the second filter mesh face 121; and a second filter second face 123 disposed opposite the second filter first face 122. The first filter mesh face 111 may be disposed to face the outside of the second filter 120 from the second filter mesh face 121, in a first direction perpendicular to the second filter mesh face 121. The second filter first face 122 may be disposed to face the first filter second face 113 from the first filter first face 112. The second filter second face 123 may be disposed to face the first filter first face 112 from the first filter second face 113. At an end of the second filter second face 123 toward the second filter inlet 124, a second filter inclined face 126 that extends to be inclined toward an end of the first filter second face 113 toward the first filter inlet 114 and is connected to the end of the first filter second face 113 may be formed. The dust outlet 140 and the dust outlet cover 160 may be disposed on the second filter inclined face 126. The filter module 100 may further include a cleaning brush 130 disposed at least partially between the first filter mesh face 111 and the second filter mesh face 121. The cleaning brush 130 may be provided in the form of a square ring, and the cleaning brush 130 may include a first brush member 131 disposed between the first filter mesh face 111 and the second filter mesh face 121; and a second brush member 132 disposed in an opposite direction of the first direction from the second filter mesh face 121. The first filter first face 112 may have a first filter first face slit 1121 formed to extend in an opposite direction from the first filter inlet 114. The first filter second face 113 may have a first filter second face slit 1131 formed to extend in the opposite direction from the first filter inlet 114. The second filter first face 122 may have a second filter first face slit 1221 formed to extend in an opposite direction from the second filter inlet 124. The second filter second face 123 may have a second filter second face slit 1231 formed to extend in the opposite direction from the second filter inlet 124. The first filter first face slit 1121 and the first filter second face slit 1131 may be a double slit. The first brush member 131 may extend through one slit portion of the first filter first face slit 1121 and one slit portion of the first filter second face slit 1131. The second brush member 132 may extend through a remaining slit portion of the first filter first face slit 1121, a remaining slit portion of the first filter second face slit 1131, the second filter first face slit 1221, and the second filter second face slit 1231. The cleaning brush 130 may further include: a first face side connecting portion 133 that connects a portion extending from the first brush member 131 through the first filter first face 112 and a portion extending from the second brush member 132 through the first filter first face 112; and a second face side connecting portion 134 that connects a portion extending from the first brush member 131 through the first filter second face 113 and a portion extending from the second brush member 132 through the first filter second face 113.

In various embodiments, the cleaning brush 130 may remove dirt or dust adhering to the first filter mesh 115 and the second filter mesh 125 by displacing with respect to the first filter 110 and the second filter 120, through the first filter first face slit 1121, the first filter second face slit 1131, the second filter first face slit 1221, and the second filter second face slit 1231. When the filter is removed from the washing-drying machine 1, the first face side connecting portion 133 may be restricted in its displacement by a first fastening portion 55 connected to the filter case 52, and the second face side connecting portion 134 may be restricted in its displacement by a second fastening portion 57 connected to the filter case 52. Thus, there may be a displacement with respect to the filter module 100.

In various embodiments, the first filter 110 may further include: a first filter first face guide rib 1122 on the first filter first face 112, formed to be spaced apart from the first filter first face slit 1121; and a first filter second face guide rib 1132 on the first filter second face 113, formed to be spaced apart from the first filter second face slit 1131. The first fastening portion 55 may be provided in an L shape, and the second fastening portion 57 may be provided in an L shape. A portion of the first fastening portion 55 along the first direction may restrict the displacement of the first face side connecting portion 133, and a portion of the second fastening portion 57 along the first direction may restrict the displacement of the second face side connecting portion 134. The first fastening portion 55 may be disposed on the side of the first direction of the first face guide rib, and a portion of the first fastening portion 55 along a direction perpendicular to the first direction may contact the first face guide rib. The second fastening portion 57 may be disposed on the side of the first direction of the second face guide rib, and a portion of the second fastening portion 57 along a direction perpendicular to the first direction may contact the second face guide rib. The first filter first face guide rib 1122 may be bent in an opposite direction of the first direction on the side of the first filter inlet 114, and the first filter second face guide rib 1132 may be bent in the opposite direction of the first direction on the side of the first filter inlet 114. The washing-drying machine 1 may include: a first spring 56 of which one side contacts the first fastening portion 55 and another side contacts a portion of the washing-drying machine 1 such that the first fastening portion 55 may move in such a bent portion; and a second spring 57 of which one side contacts the second fastening portion 57 and another side contacts a portion of the washing-drying machine 1 such that the second fastening portion 57 may move in such a bent portion. As the first fastening portion 55 and the second fastening portion 57 move in the opposite direction of the first direction, in the bent portion, the movement of the first face side connecting portion 133 and the second face side connecting portion 134 may not be restricted by the first fastening portion 55 and the second fastening portion 57.

According to various embodiments, a washing-drying machine 1 using a filter module 100 insertable into a filter connection module 200 may include: a main body 10 having a door 40 provided at the front, the main body 10 having a laundry inlet provided at the front; a tub 30 disposed inside the main body 10 to store water therein; a drum rotatably disposed inside the tub 30; a heat exchanger 70 disposed above the tub 30 and adapted to heat air supplied into the tub 30; an air blowing fan adapted to form a circulating flow path 50 that passes through the tub 30 and the heat exchanger 70; a filter case 52 having a filter case inlet of the filter case 52 provided at the rear such that air discharged from the tub 30 flows in and a filter case outlet of the filter case 52 provided at the side such that air is supplied to the heat exchanger 70; and the filter module 100 disposed to be received in the inside of the filter case 52 or withdrawn to the outside of the filter case 52. The tub 30 may include an outlet at a rear lower side and an inlet at a front upper side. The circulating flow path 50 may include: an outlet duct connected to the outlet and extending from the rear lower side of the tub 30 to one side of a rear upper portion in the main body 10; the filter case 52 connected to the outlet duct and extending from one side of the rear upper portion in the main body 10 to one side of a front upper portion in the main body 10; a heat exchange duct connected to the filter case 52 and extending from one side of the front upper portion in the main body 10 to another side; and a supply duct connected to the heat exchange duct and connected to the inlet. The filter module 100 may be inserted into a filter insertion portion provided within the filter case 52, and the filter module 100 may include: a first filter 110 of which one surface is open and including a first filter mesh 115 on a surface perpendicular to the open surface; a second filter 120 of which one surface in the same direction as the open surface of the first filter 110 is open and including a second filter mesh 125 formed on a surface toward the first filter mesh 115, with at least a portion thereof being received in the first filter 110; a dust collection space 150 formed between the first filter 110 and the second filter 120; a dust outlet 140 formed around the open surface of the first filter 110 and connecting the dust collection space 150 and the outside of the first filter 110; and a dust outlet cover 160 covering the dust outlet 140. Air in the filter case 52 may enter the open surface of the first filter 110 and pass through the second filter mesh 125 and the first filter mesh 115 to move into the heat exchange duct. The connection module 200 may include: a connection module body 210; a receiving space 250 formed inside the connection module body 210 into which at least a portion of the first filter 110 is to be inserted; a connection module inlet 220 formed at one end of the connection module body 210 and connected to the receiving space 250; a connection module outlet 240 formed at another end of the connection module body 210 and connected to the receiving space 250; and a push bar 230 extending toward the connection module inlet 220 from around the connection module outlet 240. The filter module 100 may be inserted into the connection module 200 after being removed from the filter case 52, and the push bar 230 may push the dust outlet cover 160 to open the dust outlet 140 when the filter module 100 is inserted into the connection module 200.

1. A washing machine having a drying function, comprising:
a main body having a laundry inlet at a front of the washing machine;
a tub disposed inside the main body;
a drum rotatably disposed inside the tub;
a heat exchanger disposed above the tub and configured to heat air supplied into the tub;
a fan configured to guide air through a circulating flow path that passes through the tub and the heat exchanger;
a filter case disposed on one side of the main body; and
a filter module coupleable to the filter case and decouplable from the filter case such that while the filter module is coupled to the filter case and the main body, air discharged from the tub flows through the filter module and is supplied toward the heat exchanger,
wherein the filter module comprises:
a filter mesh, and
a cleaning member configured to sweep the filter mesh to separate foreign substance caught in the filter mesh as the filter module is decoupled from the filter case.

2. The washing machine having the drying function of claim 1, wherein the air discharged from the tub flows into the filter module along a first direction and the air is supplied to the heat exchanger by being discharged through the filter mesh along a second direction perpendicular to the first direction.

3. The washing machine having the drying function of claim 2, wherein the filter module comprises:
a first filter on which the filter mesh is formed.

4. The washing machine having the drying function of claim 3, wherein at least a portion of the cleaning member is in contact with the filter mesh, and the at least the portion of the cleaning member is displaced as the filter module is being decoupled from the filter case.

5. The washing machine having the drying function of claim 4, wherein the cleaning member is in a form of a square ring, and
the cleaning member sweeps the filter mesh as the filter module is moved such that the filter module and the filter case decouple from each other.

6. The washing machine having the drying function of claim 5, wherein the filter module includes:
a slit formed to extend along the filter module, and
a guide rib formed to extend along the filter module.

7. The washing machine having the drying function of claim 6, wherein the cleaning member formed to extend inside the filter case perpendicular to the filter mesh.

8. The washing machine having the drying function of claim 7, wherein
an area of the cleaning member extends across an area of the filter mesh.

9. The washing machine having the drying function of claim 8, wherein the filter mesh is among a plurality of partial meshes spaced apart from each other.

10. The washing machine having the drying function of claim 1, further comprising:
a heat pump, arranged along the circulating flow path, to heat the air supplied into the tub.

11. The washing machine having the drying function of claim 2, wherein the filter case is arranged on an upper portion of the main body along the circulating flow path such that the air supplied to the heat exchanger is filtered through the filter mesh of the filter module.

12. The washing machine having the drying function of claim 2,
wherein the connection module comprises:
a connection module body;
a receiving space formed inside the connection module body into which at least a portion of the first filter is to be inserted;
a connection module inlet formed at one end of the connection module body and connected to the receiving space;
a connection module outlet formed at another end of the connection module body and connected to the receiving space; and
a push bar extending toward the connection module inlet from around the connection module outlet,
wherein, when the filter module is inserted into the connection module, the push bar is adapted to push the dust outlet cover to open the dust outlet.

13. The washing machine having the drying function of claim 1, wherein the filter module includes a filter mesh face arranged in a shape in which a left side and a right side are inverted, and
the filter module is coupled to the filter case by being slid along the filter case.

14. The washing machine having the drying function of claim 13, wherein
the cleaning member extends toward the filter mesh face of the filter module.

15. The washing machine having the drying function of claim 1, wherein
the tub comprises an outlet at a rear lower side of the tub and an inlet at a front upper side of the tub,
wherein the circulating flow path comprises:
an outlet duct connected to the outlet and extending from the rear lower side of the tub to one side of a rear upper portion in the main body;
the filter case connected to the outlet duct and extending from one side of the rear upper portion in the main body to one side of a front upper portion in the main body;
a heat exchange duct connected to the filter case and extending from one side of the front upper portion in the main body to another side; and
a supply duct connected to the heat exchange duct and connected to the inlet,
wherein the filter module is inserted into a filter insertion portion provided within the filter case.

16. A washing machine having a drying function, comprising:
a main body having a laundry inlet at a front of the washing machine;
a tub disposed inside the main body;
a drum rotatably disposed inside the tub;
a heat exchanger disposed above the tub and configured to heat air supplied into the tub;
a fan configured to guide air through a circulating flow path that passes through the tub and the heat exchanger;
a filter case disposed on one side of the main body; and
a filter module coupleable to the filter case and decouplable from the filter case such that while the filter module is coupled to the filter case and the main body, air discharged from the tub flows through the filter module and is supplied toward the heat exchanger,
wherein the filter module comprises:
a filter mesh through which the air supplied toward the heat exchanger is discharged while the filter module is while the filter module is coupled to the filter case, and
a cleaning brush configured to sweep the filter mesh to separate foreign substance caught in the filter mesh.

17. The washing machine having the drying function of claim 16, wherein the cleaning brush is in contact with the filter mesh.

18. The washing machine having the drying function of claim 17, wherein the cleaning brush is displaceable with respect to the filter mesh.

19. The washing machine having the drying function of claim 18, wherein the filter mesh is formed on a filter mesh face perpendicular to one open side on which a filter inlet is formed.

20. The washing machine having the drying function of claim 16, wherein the tub comprises an outlet at a rear lower side and an inlet at a front upper side,
wherein the circulating flow path comprises:
an outlet duct connected to the outlet and extending from the rear lower side of the tub to one side of a rear upper portion in the main body;
a heat exchange duct extending from one side of the front upper side in the main body to another side; and
a supply duct connected to the heat exchange duct and connected to the inlet of the tub.

21. The washing machine having the drying function of claim 20, wherein the filter case is connected to the outlet duct and the heat exchange duct, and
the filter case extends from one side of the rear upper portion in the main body to one side of a front upper portion in the main body.

22. The washing machine having the drying function of claim 21, wherein the filter case includes a filter case inlet connected to the outlet duct, and a filter case outlet connected to the heat exchange duct.
